(19) United States
(12) Patent Application Publication
(10) Pub. No.: US 2022/0408769 A1
(43) Pub. Date: Dec. 29, 2022

(54) HIGH-FIBER / LOW-SUGAR FRUIT SNACKS

(71) Applicant: PASONA KNOWLEDGE PARTNER INC., Osaka (JP)

(72) Inventors: Peter Eisner, Freising (DE); Veronica Garcia Arteaga, Schwindegg (DE)

(21) Appl. No.: 17/638,675

(22) PCT Filed: Aug. 25, 2020
(86) PCT No.: PCT/EP2020/073674

§ 371 Date: Feb. 25, 2022

Related U.S. Application Data
(60) Provisional application No. 62/891,690, filed on Aug. 26, 2019.

(51) Int. Cl. A23L 19/00; A23L 5/30; A23L 5/20

(52) U.S. Cl. CPC A23L 19/09; A23L 19/07; A23L 5/34; A23L 5/21

(57) ABSTRACT

This document provides dried products made from fruit including a press cake of constituents of at least one fruit variety, wherein a ratio of a mass of water-soluble saccharides to a mass of soluble and insoluble fiber in the press cake is less than 90% of said ratio in a raw material of the at least one fruit variety; the water content of the dried product is less than 10% by mass; methods for producing dried products made from fruit are also provided.

### CROSS-REFERENCE TO RELATED APPLICATIONS

This application claims benefit of priority from U.S. Provisional Application Ser. No. 62/891,690, filed on Aug. 26, 2019. The disclosures of the prior application is considered part of (and is incorporated by reference in) the disclosure of this application.

### TECHNICAL FIELD

The present disclosure relates to dried products made from of fruit and/or vegetables, more particularly to crispy fruit snacks made from press cakes, which have a high-fiber and low sugar content.

### BACKGROUND

Snack products are widespread in the area of processed foods. Examples of popular snacks are potato chips which in many cases are admixed with salt and/or flavoring. Fruit and vegetable snacks include especially dried fruit and vegetable pieces such as apple or pineapple slices or even entire dried fruits such as, for example, raisins, figs, dates, prunes.

Dried products from fruit may contribute to a healthy diet, because fruits are often rich in beneficial compounds such as polyphenols or vitamins. These beneficial compounds may lower cholesterol, reduce the risk of various cancers, or reduce the risk of heart disease. Additionally, dried fruit products may be characterized by a high fiber content, which may further contribute to a healthy diet.

On the other hand, known dried products from fruit may also have a high sugar content, because these products from fruit typically retain the sugar content of the fruit used as base material for the dried product. This is due to the processes involved in dehydration such as drying at elevated temperatures or microwave drying. A high sugar content of such dehydrated fruit products, however, may be in conflict with a healthy diet.

It is one object of the present disclosure to provide dehydrated fruit products that have a relatively low sugar content and a relatively high fiber content.

Further, known dried products may vary quite considerably with respect to the quality parameters sweetness, acidity and color. These variations may be due to quality differences in the raw fruit material. For instance, most fruits and vegetables vary with respect to sweetness, acidity, flavor, color and oxidation stability. Consequently, the quality parameters sweetness, acidity and color of the end products may vary quite considerably in the absence of addition of antioxidants, sugar or acid. Accordingly, in known dried fruit products a uniform color, sweetness or acidity of the end products cannot be achieved without the use of added sugar or food additives.

Moreover, known products may vary with respect to their texture. Whereas chips or peanut flips are characterized by a crispy texture, the texture of most dried fruit and vegetable snacks is more soft or gummy, meaning that many of the dried products are not consumed by the consumers as a crispy snacks, which may reduce the enjoyment of the products for many customers. To increase crispiness, some dried products such as banana or pineapple pieces are often provided with sugar and/or deep-fried in order to achieve a firmer and crispy texture. However, at the same time, the value added to said products in terms of acoustics and firmer bite may be offset by the addition of sugar or oil, meaning that the natural composition of the fruits is no longer present in the end product.

It is a further object of the present disclosure to provide dried fruit products that have a crispy texture and that are more consistent in the description of the quality parameters sweetness, acidity, flavor consistency—even without the addition of sugar or food additives.

### SUMMARY

This disclosure provides dried products based on press cakes of fruit. Press cake as used herein refers to the residue remaining after pressing juices from fruit and vegetables. The use of press cakes as raw material for dried fruit products effectively reduces the ratio of water-soluble saccharides to dietary fiber allowing for preparation of a dried fruit product, which is relatively enriched in fiber content. In some cases, the press cake is obtained from fruit materials, from which unenjoyable parts of the fruit have been removed prior to extracting liquids by pressing. For example, the stalk, the peel and or seeds can be removed prior to pressing to obtain a high quality press cake. In some cases, pressing is performed in a careful and non-exhaustive manner to obtain a partially dejuiced press cake. As described herein, the use of such a high quality, partially dejuiced press cake allows for the preparation of particularly tasty fruit snacks with a relatively high fiber, but relatively low sugar content.

In some cases, the press cake can be obtained from the by-product of fruit juice production. In such cases, the further utilization of press cake from juice production allows the use of raw material typically considered as waste to create healthy fruit snacks.

Processing of the press cakes as described herein by mechanical comminution and dehydrating at low temperatures and under reduced pressure conditions provides dried fruit products that have a crispy texture and that are more consistent in the description of the quality parameters sweetness, acidity, flavor consistency even without the addition of sugar or food additives.

In one aspect, this document provides a dried product made from fruit including a press cake of constituents of at least one fruit variety, wherein a ratio of a mass of water-soluble saccharides to a mass of soluble and insoluble fiber in the press cake is less than 90% of said ratio in a raw material of the at least one fruit variety. The water content of the dried product is less than 10% by mass. In some embodiments, the ratio of a mass of water-soluble saccharides to a mass of soluble and insoluble fiber in the press cake is less than 80% (e.g., less than 70%, less than 60%, less than 50%, less than 40%, less than 30%, or less than 20%) of said ratio in a raw material of the at least one fruit variety. In some embodiments, the ratio of a mass of water-soluble saccharides to a mass of soluble and insoluble fiber in the press cake is 20%-90% (e.g., 30%-80%, 40%-70%, or 50%-60%) of said ratio in a raw material of the at least one fruit variety.

In another aspect, this document provides a dried product made from fruit including a press cake of constituents of at least one fruit variety, wherein a ratio of a mass of water-soluble saccharides to a mass of soluble and insoluble fiber in the press cake is between 0.2 and 9.2. The water content of the dried product is less than 10% by mass. In some embodiments, the ratio of a mass of water-soluble saccharides to a mass of soluble and insoluble fiber in the press cake is between 0.5 and 8.5 (e.g., between 1.0 and 8.0, between 1.5 and 7.5, between 2.0 and 7.0, between 2.5 and 6.5, between 3.0 and 5.5, between 3.5 and 5.0, or between 4.0 and 4.5). In some embodiments, the at least one fruit variety is pineapple, and the ratio is between 1.4 and 6.3. In some embodiments, the at least one fruit variety is apple, and rein said ratio is between 0.9 and 3.9. In some embodiments, the at least one fruit variety is orange, and the ratio is between 0.8 and 3.5. In some embodiments, the at least one fruit variety is grapefruit, and the ratio is between 1.3 and 5.7. In some embodiments, the at least one fruit variety is guava, and wherein said ratio is between 0.3 and 1.5. In some embodiments, the at least one fruit variety is pear, and the ratio is between 0.6 and 2.8. In some embodiments, the at least one fruit variety is mango, and the ratio is between 1.7 and 7.7. In some embodiments, the at least one fruit variety is grape, and the ratio is between 2.0 and 9.1. In some embodiments, the at least one fruit variety is apricot, and the ratio is between 1.1 and 4.8. In some embodiments, the at least one fruit variety is peach, and the ratio is between 0.9 and 4.0. In some embodiments, the at least one fruit variety is sour or sweet cherry, and the ratio is between 2.0 and 9.2. In some embodiments, the at least one fruit variety is sour cherry, and the ratio is between 2.0 and 8.9. In some embodiments, the at least one fruit variety is plum, and the ratio is between 1.3 and 5.7. In some embodiments, the at least one fruit variety is blackberry, and the ratio is between 0.4 and 1.7. In some embodiments, the at least one fruit variety is strawberry, and the ratio is between 0.7 and 3.2. In some embodiments, the at least one fruit variety is fig, and the ratio is between 1.3 and 5.9. In some embodiments, the at least one fruit variety is papaya, and the ratio is between 0.8 and 3.8.

Implementations of these aspects can include one or more of the following features.

The content of water-soluble saccharides in the dried product can be less than 85% and more than 30% of the content of water-soluble saccharides in the constituents of the at least one fruit variety.

The content of water-soluble saccharides in the dried product can be less than 80% and more than 35% of the content of water-soluble saccharides in the constituents of the at least one fruit variety.

The press cake can be a comminuted press cake. In some embodiments, less than 90% of the cells of the constituents of the at least one fruit variety are intact.

The dried product can include a surface, the surface of the dried product having a lightness value in the L*a*b* color space with a standard deviation of less than 10.

The dried product can have a crispy texture, a crispy texture being characterized by a fracture force in the range of between 150 g and 500 g (e.g., 200 g-450 g, 250 g-400 g, or 300 g-350 g).

The dried product can have the shape of a sheet. The sheet can have a thickness of 0.9-10 mm.

The at least one fruit variety can be selected from the group consisting of pineapple, chokeberry, banana, date, strawberry, goji berry, raspberry, blueberry, blackberry, kiwifruit, melon, fig, peach, apricot, grape, physalis, currant, grapefruit, orange, lime, lemon, coconut, pear, acerola, mandarin, cherimoya, dragon fruit, pomegranate, guava, rosehip, cherry, lychee, mango, passion fruit, mirabelle, plum, cranberry, sea buckthorn, quince, gooseberry, acai, elderberry, papaya, lucuma and any combination of two or more of these.

The press cake can further include constituents of at least one vegetable. The at least one vegetable can be selected from the group consisting of avocado, pumpkin, carrot, tomato, zucchini, onion, garlic, curcuma, beetroot, potato, pepper, spinach, corn, artichoke, eggplant, cucumber, radish, leek, yam, cauliflower, broccoli, red cabbage, white cabbage, snap peas, fresh peas, beans, fennel, ginger, kohlrabi, parsnips, rhubarb, Brussel sprout, black salsify, celery, Chinese cabbage, mache, rocket, chard, chicory, kale, lettuce, iceberg lettuce, maca, sprouts, mushrooms, bell peppers, chili peppers, olives and any combination of two or more of these.

The dried product can further include at least one spice. The at least one spice can be selected from the group consisting of curry, curcuma, ginger, cinnamon, capsicum powder, garlic powder, caraway, pepper, salt, chili powder, cumin, cardamon, coriander seed, nutmeg, orange peel, lemon peel, saffron and any combination of two or more of these.

The dried product can include at least one type of kernels or seeds in the herein-described dried products, such as, for example: linseeds, chia seeds, sesame, hempseeds, psyllium seeds, sunflower seeds, poppy seeds, pumpkin seeds, pine kernels, cumin seeds, fennel seeds, aniseeds, fenugreek seed or mustard seed.

The dried product can further include herbs. The herbs can be selected from the group consisting of parsley, basil, chives, dill, oregano, rosemary, marjoram, lovage, sage, ramson, savory, borage, stinging nettle, tarragon, chervil, coriander, mint, woodruff and any combination of two or more of these.

In another aspect, this document provides a method for producing a dried product made from fruit. The method includes the following steps: Providing constituents of at least one fruit variety; pressing the constituents of the at least one fruit variety to obtain a press cake, wherein pressing reduces a ratio of a mass of water-soluble saccharides to a mass of soluble and insoluble fiber in the press cake to less than 90% of said ratio in the provided constituents of the at least one fruit variety; predrying the press cake to obtain a predried mass, wherein the water content is reduced to a proportion by mass of from 60% to 35%; and microwave drying the predried mass under reduced pressure conditions, wherein the water content of the resulting dried product is less than 16% of the mass of the dried product. In some embodiments, the ratio of a mass of water-soluble saccharides to a mass of soluble and insoluble fiber in the press cake is less than 80% (e.g., less than 70%, less than 60%, less than 50%, less than 40%, less than 30%, or less than 20%) of said ratio in the provided constituents of the at least one fruit variety. In some embodiments the microwave drying can reduce the water content of the resulting dried product to 15%-10% (e.g., 14%-11%, 13%, or 12%) of the mass of the dried product.

Implementations of this aspect may include one or more of the following features.

The method can include removing inedible parts of the at least one fruit variety prior to pressing. The inedible parts may include the stem, the peel, and or the seeds.

The pressing can reduce the water content of the constituents of the at least one fruit variety to a proportion by mass of less than 85% and more than 60%, preferably less 80% and more than 65%. The pressing can reduce the content of water-soluble saccharides in the press cake as compared to the content of water-insoluble saccharides in the provided constituents of the at least one fruit variety.

The method can include comminuting the press cake to form a moist mass.

The predrying can be carried out at a temperature of less than 80° C. and more than 40° C. The predrying can be carried out under reduced partial pressure of oxygen, for example at a partial pressure of oxygen of less than 100 mbar and more than 10 mbar.

The microwave drying can be carried out at a temperature of less than 80° C. and more than 40° C. The microwave drying can be carried out under reduced pressure conditions of less than 100 mbar and more than 10 mbar. The microwave drying can include an expansion of a volume to 110% to 150% of a volume of the predried mass.

The method can further include foaming up the press cake using an inert gas. The inert gas used for the foaming-up can be N₂. The proportion of inert gas after the foaming-up can be 10 to 30% by volume of the press cake.

The providing step can include providing constituents of at least two different fruit varieties. The providing step can include providing constituents of at least one vegetable variety.

The comminuting step can include puréeing the constituents of the at least one fruit variety to form an injectable mass, and may include an extensive breakup of cellular structures.

The method can further include postdrying the microwave-dried mass, for example to a water content of less than 10% by mass of the dried product, preferably less than 7%. In some embodiments, the postdrying can reduce the water content from 9% to 3% (e.g., 8%-4%, 7%-5%, or 6%) by mass of the dried product.

In another aspect, this document provides a method for producing a dried product made from fruit. The method includes: Providing constituents of at least one fruit variety; pressing the constituents of the at least one fruit variety to obtain a press cake, wherein the water content of the constituents of the at least one fruit variety is reduced to a proportion by mass of less than 90%; predrying the press cake to form a predried mass, wherein the water content of the mass is reduced to a proportion by mass of from 60% to 30%; and microwave drying the predried mass under reduced pressure conditions, wherein the water content of the resulting dried product is less than 10% of the mass of the dried product.

Implementations of this aspect may include one or more of the following features.

The method can include removing inedible parts of the at least one fruit variety prior to pressing. The inedible parts may include the stem, the peel, and or the seeds.

The pressing can reduce the water content of the constituents of the at least one fruit variety to a proportion by mass of less than 85% and more than 60%, preferably less 80% and more than 65%. The pressing can reduce the content of water-soluble saccharides in the press cake as compared to the content of water-insoluble saccharides in the provided constituents of the at least one fruit variety.

The method can include comminuting the press cake to form a moist mass.

The predrying can be carried out at a temperature of less than 80° C. and more than 40° C. The predrying can be carried out under reduced partial pressure of oxygen, for example at a partial pressure of oxygen of less than 100 mbar and more than 10 mbar.

The microwave drying can be carried out at a temperature of less than 80° C. and more than 40° C. The microwave drying can be carried out under reduced pressure conditions of less than 100 mbar and more than 10 mbar. The microwave drying can include an expansion of a volume to 110% to 150% of a volume of the predried mass.

The method can further include foaming up the press cake using an inert gas. The inert gas used for the foaming-up can be N₂. The proportion of inert gas after the foaming-up can be 10 to 30% by volume of the press cake.

The providing step can include providing constituents of at least two different fruit varieties. The providing step can include providing constituents of at least one vegetable variety.

The comminuting step can include puréeing the constituents of the at least one fruit variety to form an injectable mass, and may include an extensive breakup of cellular structures.

The method can further include postdrying the microwave-dried mass, for example to a water content of less than 7% by mass of the dried product.

In yet another aspect, this document provides a dried product made from fruit. The dried product includes a press cake of constituents of at least one fruit variety, wherein the content of water-soluble saccharides in the dried product is less than 90% of the content of water-soluble saccharides in the constituents of the at least one fruit variety, and wherein the water content of the dried product is less than 10% by mass.

Implementations of this aspect may include one or more of the following features.

The content of water-soluble saccharides in the dried product can be less than 85% and more than 30% of the content of water-soluble saccharides in the constituents of the at least one fruit variety.

The content of water-soluble saccharides in the dried product can be less than 80% and more than 35% of the content of water-soluble saccharides in the constituents of the at least one fruit variety.

The press cake can be a comminuted press cake. In some embodiments, less than 90% of the cells of the constituents of the at least one fruit variety are intact.

The dried product can include a surface, the surface of the dried product having a lightness value in the L*a*b* color space with a standard deviation of less than 10.

The dried product can have a crispy texture, a crispy texture being characterized by a force-time chart according to the Liu method for the dried product having at least 5 peaks, and at least 3 peaks having a peak height of at least 5% of the height of the maximum peak.

The dried product can have the shape of a sheet. The sheet can have a thickness of 3-15 mm.

The at least one fruit variety can be selected from the group consisting of pineapple, chokeberry, banana, date, strawberry, goji berry, raspberry, blueberry, blackberry, kiwifruit, melon, fig, peach, apricot, grape, physalis, currant, grapefruit, orange, lime, lemon, coconut, pear, acerola, mandarin, cherimoya, dragon fruit, pomegranate, guava, rosehip, cherry, lychee, mango, passion fruit, mirabelle, plum, cranberry, sea buckthorn, quince, gooseberry, acai, elderberry, papaya, lucuma and any combination of two or more of these.

The press cake can further include constituents of at least one vegetable. The at least one vegetable can be selected from the group consisting of avocado, pumpkin, carrot, tomato, zucchini, onion, garlic, curcuma, beetroot, potato, pepper, spinach, corn, artichoke, eggplant, cucumber, radish, leek, yam, cauliflower, broccoli, red cabbage, white cabbage, snap peas, fresh peas, beans, fennel, ginger, kohlrabi, parsnips, rhubarb, Brussel sprout, black salsify, celery, Chinese cabbage, mache, rocket, chard, chicory, kale, lettuce, iceberg lettuce, maca, sprouts, mushrooms, bell peppers, chili peppers, olives and any combination of two or more of these.

The dried product can further include at least one spice. The at least one spice can be selected from the group consisting of curry, curcuma, ginger, cinnamon, capsicum powder, garlic powder, caraway, pepper, salt, chili powder, cumin, cardamon, coriander seed, nutmeg, orange peel, lemon peel, saffron and any combination of two or more of these.

The dried product can include at least one type of kernels or seeds in the herein-described dried products, such as, for example: linseeds, chia seeds, sesame, hempseeds, psyllium seeds, sunflower seeds, poppy seeds, pumpkin seeds, pine kernels, cumin seeds, fennel seeds, aniseeds, fenugreek seed or mustard seed.

The dried product can further include herbs. The herbs can be selected from the group consisting of parsley, basil, chives, dill, oregano, rosemary, marjoram, lovage, sage, ramson, savory, borage, stinging nettle, tarragon, chervil, coriander, mint, woodruff and any combination of two or more of these.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1: Flow chart of a method for producing dried products from press cake.

FIG. 2: Sugar and Vitamin C content of dried products.

FIG. 3: Color values of dried products.

FIGS. 4A-C: Nutritional values and sugar to fiber ratio of dried products based on press cake.

FIG. 5: Sugar to fiber ratios of various raw fruit materials compared to a range of ratios obtainable for dried products based on press cake in accordance with the invention.

FIG. 6: Characterization of dried fruit products based on press cake according to the invention.

FIGS. 7A-D: Color values of further dried products based on press cake according to the invention.

FIGS. 8A-B: Thicknesses and fracture force measurements of dried products based on press cake according to the invention and commercial products.

### DETAILED DESCRIPTION

This document provides dried products and methods for producing dried products based on press cakes of fruit, which have a reduced ratio of water-soluble saccharides to dietary fiber. This invention provides a multitude of advantages and technical effects. The dried products may contribute to a healthy diet because of their relatively reduced content of water-soluble saccharides and relatively enriched fiber content. At the same time, beneficial components such as antioxidants and polyphenols can be retained in the press cake. Using a press cake as raw material may also allow for an effective reutilization of left over materials from juice production. Further, pressing cake and subsequent comminuting of fruit constituents allows for the use of fruit with an appearance that would not be sufficiently appealing for the retail industry. This reduces the need for specific selection of the starting materials. Further, costs can be reduced. Pressing and comminuting as described herein additionally lead to an advantageous homogenization of properties with respect to taste and color.

The term dietary fiber as used herein relates to the edible parts of plants or analogous carbohydrates that are resistant to digestion and absorption in the human small intestine, with complete or partial fermentation in the large intestine. Dietary fiber includes polysaccharides, oligosaccharides, lignin, and associated plant substances. Dietary fibers promote beneficial physiologic effects including laxation, and/or blood cholesterol attenuation, and/or blood glucose attenuation.

The term dietary fiber encompasses two main components, soluble fiber and insoluble fiber. Soluble fiber—which dissolves in water—is generally fermented in the colon into gases and physiologically active by-products, such as short-chain fatty acids produced in the colon by gut bacteria. Fermentable fibers are called prebiotic fibers. Examples are beta-glucans (in oats, barley, and mushrooms) and raw guar gum. An exception is psyllium, which is a soluble, viscous, non-fermented fiber. Psyllium is a bulking fiber that retains water as it moves through the digestive system, easing defecation. Soluble fiber is generally viscous and delays gastric emptying which, in humans, can result in an extended feeling of fullness. Exceptions are inulin (in onions), wheat dextrin, oligosaccharides, and resistant starches (in legumes and bananas), which are non-viscous. Insoluble fiber—which does not dissolve in water—is inert to digestive enzymes in the upper gastrointestinal tract. Examples are wheat bran, cellulose, and lignin. Coarsely ground insoluble fiber triggers the secretion of mucus in the large intestine, providing bulking. Finely ground insoluble fiber does not have this effect and can actually have a constipating effect. Some forms of insoluble fiber, such as resistant starches, can be fermented in the colon.

The term water-soluble saccharides relates to carbohydrates that are soluble in water. The term water-soluble saccharides encompasses, but is not limited to monosaccharides and disaccharides. In preferred embodiments, the term water-soluble saccharides relates to monosaccharides and disaccharides. The term monosaccharides includes, but is not limited to glucose and fructose. The term disaccharides includes, but is not limited to lactose, maltose, sucrose, and saccharose. The term water-soluble saccharides encompasses sugars.

The term sugar as used herein relates to sweet-tasting, soluble carbohydrates, many of which are used in food. The term sugar as used herein encompasses, but is not limited to glucose, fructose, lactose, sucrose, maltose, and saccharose. Sugars as used herein are water-soluble saccharides.

The term carbohydrate as used herein relates to biomolecules consisting of carbon (C), hydrogen (H) and oxygen (O) atoms. The term carbohydrates as used herein includes four main groups: monosaccharides, disaccharides, oligosaccharides, and polysaccharides.

The ratio of a mass of water-soluble saccharides to a mass of soluble and insoluble fibers as described herein can be determined as follows. The mass of a water soluble saccharide can be determined by sugar spectrum HPLC detecting saccharides such as fructose, glucose, sucrose, lactose, and maltose (DIN 10758: 1997-05 (mod.) The mass of the water-soluble saccharides can then be obtained by summing up the determined masses for individual water-soluble saccharides. The mass of soluble and insoluble fibers determined based on standardized method § 64 LFGB L 00.00-18: 1997-01. The thus obtained absolute ratio can be converted into a relative ratio as compared to the known masses of water-soluble saccharides and soluble and insoluble fibers in the raw material of corresponding fruit varieties.

Raw material as used herein can refer to the whole fruit. It can also refer to constituents of a fruit variety where inedible parts have been removed. For example, the stem, the peel, and/or the fruit can be removed to provide constituents of high quality for further processing in subsequent steps.

The steps of the methods and the properties of the dried products of the present invention will be described in detail below.

### Providing

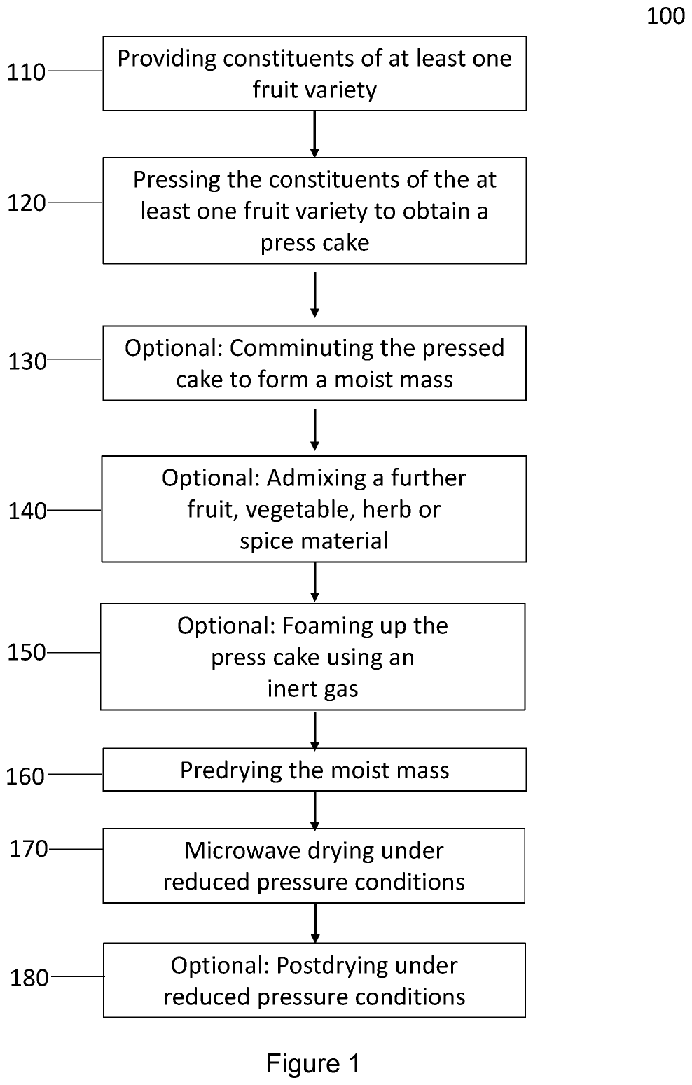

Providing constituents of at least one fruit variety as starting material is a first step in the herein-described method for producing a dried product according to the invention (step 110 in FIG. 1).

For this purpose, it is possible to use fruit varieties of various degrees of ripeness. The use of fruit with a high degree of ripeness can contribute to more crispy and more flavorful dried products. This can allow the use of fruit with such a high degree of ripeness that would otherwise no longer be suitable for sale.

Providing constituents of at least one fruit variety can include removing inedible parts from the fruit. For example, the stem, the peel, and/or the fruit can be removed to provide constituents of high quality for further processing in subsequent steps.

In some embodiments, one or more of the following fruit varieties alone or in any desired combination can be used to produce the dried products described herein: pineapple, chokeberry, banana, date, strawberry, goji berry, raspberry, blueberry, blackberry, kiwifruit, melon, fig, peach, apricot, grape, physalis, currant, grapefruit, orange, lime, lemon, coconut, pear, acerola, mandarin, cherimoya, dragon fruit, pomegranate, guava, rosehip, cherry, lychee, mango, passion fruit, mirabelle, plum, cranberry, sea buckthorn, quince, gooseberry, acai, elderberry, papaya, or lucuma.

### Pressing

In the next step, (step 120 in FIG. 1), the constituents of the at least one fruit variety are pressed to obtain a press cake. Press cake as used herein refers to the residue remaining after pressing juices from fruit and vegetables. Pressing reduces the water content and the content in water-soluble saccharides resulting in a relative enrichment of the fiber content.

Any appropriate means known in the art can be used to reduce the water and sugar content by pressing. For example, an expeller press or a filter press can be used to obtain the press cake.

Pressing can reduce the water content of the constituents of the at least one fruit variety to a proportion by mass of less than 90%, preferably to less than 85% and more than 60%, more preferably to less than 80% and more than 65%. The removed water-soluble saccharides may include, but is not limited to monosaccharides such as glucose, fructose, and/or sucrose. Pressing can reduce the content of water-soluble saccharides in the dried product to less than 90% of the content of water-soluble saccharides in the constituents of the at least one fruit variety. For example, the content of water-soluble saccharides in the press cake can be 80% or less (e.g., 70%, 60%, 50%, or 40%) of the content of water-soluble saccharides in the provided constituents of the at least one fruit variety.

The content in water soluble saccharides can be determined as weight % based on the dry weight of the constituents of a fruit variety. The content in water soluble saccharides can be determined as weight % based on the dry weight of the press cake. The content in water soluble saccharides can be determined as weight % based on the dry weight of the dried product.

To obtain a press cake, constituents of a fruit variety can be place on frames and subjected to a force of 2-10 kg/m². In preferred embodiments a force of ca. 5 kg/m2 is applied. The force can be varied based on the type of fruit and depending on the desired texture.

The reduced water content of the press cake may have a positive influence on the structure and crispiness of the dried product.

### Comminuting

In the next step, the press cake is optionally subjected to mechanical comminution to produce a moist mass (step 130 in FIG. 1) which can be further processed in subsequent method steps to yield a dried product having desired properties in terms of texture and flavor.

Depending on the degree of comminution, the proportion of intact cells can vary. The proportion of intact cells of the herein-described dried products is, as a result of the comminution, reduced in comparison with conventional fruit or vegetable snacks made from entire fruits or large fruit pieces. Upon comminution, the proportion of intact cells can be reduced to less than 90% (e.g., less than 80%, less than 70%, less than 60% or less than 50%) of the intact cells of the provided constituents of the at least one fruit variety.

The constituents of the at least one fruit variety can be comminuted using different instruments. Crushing or mortar-and-pestle action is possible too. For example, it is possible to use cutting mills, rollers, mixers, cutters, mortar and pestles, or colloid mills. The comminution yields a moist mass which can have the consistency of a purée. The moist mass (e.g., the purée) can be varied in terms of its viscosity by appropriate selection of the degree of comminution.

Since some of the cellular and other protective structures of the constituents of the at least one fruit variety are broken up during the comminution process, it may be advantageous to reduce the presence of atmospheric oxygen during the comminution process. This can, for example, prevent oxidation reactions of polyphenols, which can lead to considerable color changes in some fruit species such as, for example, bananas or apples. The exclusion of oxygen makes it possible to largely preserve the native color of the fruit constituents in the resulting dried products, whereas the color of products processed in the presence of oxygen becomes darker and browner. Furthermore, the absence of atmospheric oxygen can protect against vitamin loss (e.g., vitamin C). During the comminution, the partial pressure of oxygen can be reduced to less than 100 mbar (e.g., less than 90 mbar or less than 70 mbar or less than 50 mbar). It has been found to be advantageous to reduce the partial pressure of oxygen during the comminution to less than 50 mbar (e.g., to 45 mbar, 40 mbar or 35 mbar). It may be particularly advantageous to reduce the partial pressure of oxygen to less than 30 mbar (e.g., to 25 mbar, 20 mbar or less). A possible alternative to the exclusion of oxygen is to add acidic fruit juice to the moist mass or to coat the moist mass with fruit juice, the result being that an undesired discoloration can likewise be reduced. Furthermore, it is possible to combine a reduction in the partial pressure of oxygen with the addition of acidic fruit juice.

The degree of comminution can be selected depending on the starting material such that the dried product exhibits the properties of crispiness, texture, volume increase (expansion) or flavor in a desired manner.

### Mixing

The herein-described dried products can be produced from constituents of at least one fruit variety. However, it is also optionally possible to mix constituents of two or more fruit varieties (e.g., of 3, 4, 5 or more fruit varieties) (step 140 in FIG. 1). Optionally, it is also possible to admix vegetables, herbs or seeds in comminuted or uncomminuted form. In this connection, the purée or the crude mass can be produced by comminution of the intended mixture or the individual components can be comminuted separately and then brought together as moist masses. As a result, different shapes and colors are possible depending on the fruit varieties mixed.

Additionally, comminution to varying degrees as desired, allow, in conjunction with a subsequent mixing step, a multitude of possible combinations. Further, less comminuted constituents of a further vegetable variety, for examples pieces or slices, can be introduced as filler into an already puréed moist mass.

It is possible to obtain dried products according to the invention that are advantageous in terms of taste when the proportion of comminuted constituents of the at least one fruit variety in the dried product is more than 80% by mass (e.g., 81%, 82%, 83%, 84%, 85%, 86%, 87%, 88%, 89%, 90%, 91%, 92%, 93%, 94%, 95%, 96%, 97%, 98%, 99% or 100%).

With respect to the mixing of different raw materials, a multitude of variations is possible. Different raw materials are understood here to mean either different fruit/vegetable varieties or species or simply just different fruits or plants of the same harvest, or fruits/vegetables of different harvests, varieties or species or respectively fruit/vegetable constituents thereof. This means that mixtures consisting only of bananas of one harvest or different harvests are just as possible as mixtures composed of various fruit/vegetable varieties or species, as are known nowadays as smoothies for example. Mixtures composed of plants or fruits of the same harvest, for example of bananas of different degrees of ripeness, are possible too.

Some methods for combining and mixing or blending the raw materials are described below by way of example:

Blending different raw materials to form a mash, a pasty mass or a mixture containing pieces.

Blending different raw materials to form a liquid mixture, for example by puréeing, stirring or kneading.

Sprinkling fruit or vegetable pieces with juice or concentrate of other fruits, plants or vegetables, which can also originate from the same species, variety or harvest as the fruits/vegetables of the fruit or vegetable pieces.

Particularly advantageously, the mixing or blending of the individual raw materials is also carried out under a reduced oxygen atmosphere in order to minimize the oxidation of the raw materials. For this purpose, it is possible to process the raw materials under vacuum or under a protective-gas atmosphere (e.g., nitrogen). If necessary, this processing can also be combined with storage of the raw materials with extensive exclusion of oxygen.

If, after the blending of the different raw materials or of a raw material in differing degree of comminution, the original shape of the fruit and/or vegetable varieties or the constituents thereof is altered, it is possible to take measures after the mixing process in order to reacquire from the mixture individual portions which can be transferred to a dry, crispy form. This can be achieved through simple portioning before the drying, for example into appropriate shapes such as hearts, stars, flowers, circles, triangles, squares or the like.

As described herein, the at least one comminuted fruit variety of the dried products according to the invention can be mixed with a multitude of vegetable varieties, herbs, spices or seeds individually or in combination and in variable degrees of comminution.

Various vegetable varieties can be used in the herein-described dried products. Examples of these include: avocado, pumpkin, carrot, tomato, zucchini, onion, garlic, curcuma, beetroot, potato, pepper, spinach, corn, artichoke, eggplant, cucumber, radish, leek, yam, cauliflower, broccoli, red cabbage, white cabbage, snap peas, fresh peas, beans, fennel, ginger, kohlrabi, parsnips, rhubarb, Brussel sprout, black salsify, celery, Chinese cabbage, mache, rocket, chard, chicory, kale, lettuce, iceberg lettuce, maca, sprouts and germ buds (e.g., cress, soybean sprouts), mushrooms, bell peppers, chili peppers or olives.

As described herein, herbs can also be used in the dried products of the present invention. Examples of these include: parsley, basil, chives, dill, oregano, rosemary, marjoram, lovage, sage, ramson, savory, borage, stinging nettle, tarragon, chervil, coriander, mint or woodruff.

Spices, too, can be used individually or in combination in the dried products according to the invention. Examples of these include: curry, curcuma, ginger, cinnamon, capsicum powder, garlic powder, caraway, pepper, salt, chili powder, cumin, cardamon, coriander seed, nutmeg, orange peel, lemon peel or saffron.

Furthermore, it is also possible to use different kernels or seeds in the herein-described dried products, such as, for example: linseeds, chia seeds, sesame, hempseeds, psyllium seeds, sunflower seeds, poppy seeds, pumpkin seeds, pine kernels, cumin seeds, fennel seeds, aniseeds, fenugreek seed or mustard seed.

Lastly, further additives in relation to the dried products according to the invention are possible for coloration, taste optimization or for increasing certain ingredients such as polyphenols, vitamins or minerals. Examples of these include: algae (Chlorella, Spirulina), dried leaves (matcha, green tea, black tea), vanilla, wheatgrass, barley grass, moringa or cacao nibs.

### Foaming-Up

Optionally, the press cake can be foamed up using an inert gas (step 150 in FIG. 1). Thus, with respect to the volume, the crispiness and the consumption acoustics of the dried products, it may be found that foam-up of the press cake, using gas or vapor leads to a disproportionately better volume increase in microwave drying under reduced pressure conditions. In this connection, even a proportion of 10-30% by volume (e.g., 15%, 20%, 25% or 30%) of gas or vapor bubbles in the press cake can, depending on the raw material, lead to the volume of the dried products after the expansion or puff-up by microwave drying being greater by a factor of 2-5 times (e.g., 2, 3, 4 or 5 times) than the volume of the predried mass before the puff-up by microwave drying. Depending on the amount of inert gas used for the foam-up, distinctly larger expansion factors are also possible. For example, an expansion by a factor of 5-10 is possible.

Moreover, the input of gas or foam can increase the crispiness and reduce the hardness of the final products, and this in turn can have a positive effect on consumption experience. However, the proportion of gas or vapor in the predried mass should also not be chosen at too high a level, so that the firmness of the products and a noticeable resistance when chewing is preserved (crispiness). For instance, in the case of an input of gas into the predried mass, a value of 80% by volume of gas in the mass should not be exceeded; preferably, the value of the proportion of gas should be between 5-50% by volume (e.g., 45%, 40%, 35%, 30%, 25%, 20%, 15% or 10%).

The input of foam can be carried out in different ways. For example, nitrogen or another inert gas can be blown into the moist mass at a water content>60% or else even during the drying. However, nitrogen which is situated above the mass can also be inputted into the moist mass by stirring or other mechanical agitation by means of dispersers or rapidly running blades. Furthermore, the input of foam or gas can be integrated into the fruit comminution process before the predrying. However, in the latter case, it should be ensured that the foam does not completely escape from the mass again during the predrying. This can be achieved by use or addition of raw materials which strongly tend to foam during evaporation, such as bananas for example.

### Predrying

In the context of the method step for the predrying (160 in FIG. 1), various methods suitable for drying are possible in principle. Examples include vacuum methods such as freeze-drying, microwave drying/puffing or other methods which are suitable for the production of crispy and largely anhydrous products. Preferably, the predrying can be carried out under a continuous stream of nitrogen, argon or carbon dioxide, since this has a positive effect on the preservation of color of the product.

Predrying may prove advantageous in the production of dried products according to the invention made from comminuted or puréed moist masses, as described herein. Firstly, the predrying serves to produce cohesive masses for better shaping, which masses, however, must still contain a certain amount of water for a further microwave vacuum expansion. The water present in the moist mass can then be stimulated by the microwave used under reduced pressure conditions, it being possible for the predried mass to be inflated or expanded by means of the evaporation process getting under way. During a postdrying process taking place afterwards, sugar constituents can crystallize or solidify amorphously to form a stable and brittle structure.

The press cake can be concentrated to a water content of 60-35% (e.g., to 45%, or 55%) in an evaporation or drying unit closed off from the surroundings, preference being given to largely excluding contact with atmospheric oxygen. This can take place either in a closed evaporator or dryer which is operated at pressures distinctly below atmospheric pressure (vacuum) and/or is filled or flushed with nitrogen. During the predrying, the partial pressure of oxygen can be reduced to less than 100 mbar (e.g., less than 90 mbar, less than 70 mbar or less than 50 mbar) and more than 10 mbar. It proves advantageous to reduce the partial pressure of oxygen during the predrying to less than 50 mbar (e.g., 45 mbar, 40 mbar or 35 mbar). It may be particularly advantageous to reduce the partial pressure of oxygen to less than 30 mbar (e.g., 25 mbar or 20 mbar or less).

Furthermore, it is advantageous when temperatures higher than 80° C. are prevented from occurring in the moist mass. During the predrying, the temperature in the moist mass can, for example, be held below 70° C., advantageously below 60° C. and particularly advantageously below 50° C. The combination of reduced temperature during the drying and oxygen exclusion makes it possible to preserve many of the constituents of fruits that are important in terms of nutritional physiology (vitamins, antioxidants, etc.).

The moisture required in the predried mass for microwave drying under reduced pressure conditions can be between 35 and 60%, preferably between 45 and 55%, depending on the product in order to generate a puffed mass having the desired crispiness and texture.

### Microwave Drying

In the context of the herein-described method for producing a dried product, microwave drying (step 170 in FIG. 1) can be carried out under various conditions. Of particular importance in this connection are the applied vacuum or the reduced pressure conditions, the temperature, the duration of the procedure, and the intensity of the microwave radiation. These can be chosen such that, depending on the constituents used, the dried product subsequently has desired properties regarding volume, crispiness, texture, flavor, etc.

Desirable properties for a herein-described dried product can, for example, be achieved at temperatures of less than 80° C. and more than 40° C., preferably less than 70° C., particularly preferably at temperatures of less than 60° C. (e.g., 55° C., 50° C. or less). With respect to the vacuum, advantageous results for dried products according to the invention are achieved at reduced pressure conditions of below 100 mbar (e.g., of 90 mbar, 80 mbar, 70 mbar, 60 mbar) and above 10 mbar. Particularly advantageous dried products are observed at reduced pressure conditions of less than 50 mbar (e.g., at 40 mbar, 30 mbar, 20 mbar or less). The intensity of the microwave radiation can be between about 10 and 30 W*g⁻¹. In principle, the parameters pressure, temperature, duration, and microwave radiation intensity can be varied in a mutually dependent manner such that a dried product having desirable properties is obtained.

Following the microwave drying, the thus obtained expanded or puffed mass can be subjected to a relatively long, gentle postdrying (FIG. 1, step 180). In the case of dried products according to the invention, postdrying can usually be carried out at temperatures of 35-60° C. (e.g., at 40, 45, 50 or 55° C.). Depending on the temperature and pressure, the postdrying can last up to 6 hours (e.g., 1, 1.5, 2, 2.5, 3, 3.5, 4, 4.5, 5 or 5.5 hours). The postdrying is preferably carried out under reduced pressure conditions similar to those of the microwave drying. Postdrying can reduce the water content to 2% to 10% by weight (e.g., 3%-9%, 4%-8%, 5%-6%, 6%, 7%, 8% or 9%).

The expansion ratio can be used as a quantitative variable for the quality of the microwave drying. This can be calculated using the formula below:

Expansion=(V₂/V₁)*100% Formula (1)

Here, V₁ is the volume of the sample before the microwave drying and V₂ is the volume after the microwave drying. The expansion is primarily dependent on the fruit and/or vegetable varieties used, the proportion of gas or foam, and the water content of the sample during the microwave drying. If too little water is present in a predried mass (<30%), insufficient expansion by means of microwave drying under reduced pressure conditions may take place. An excessively high amount of water in a moist and predried mass (>60%) similarly has a negative effect on the expansion by means of microwave drying under reduced pressure conditions, since the predried mass still has too little solid structure in order to be able to withstand the stretching of the mass due to the evaporating water. A light skin supports the stretching of the mass and the postdrying can stabilize the shape.

Depending on the starting materials used, expansion factors can be between 87% and 275% or more (e.g., at 90%, 100%, 110%, 120%, 130%, 140%, 150%, 160%, 170%, 180%, 190%, 200%, 210%, 220%, 230%, 240%, 250%, 260%, 270%). After prior introduction of inert gas, this value can be additionally exceeded depending on the proportion by volume of gas. Particularly crispy textures are observed when a volume of the dried product according to the invention is 150% or more of a volume of the predried mass, i.e., has expansion factors of about 150% or more of the predried mass.

### Shape and Appearance

Shape and appearance of dried products produced according to the herein-described methods can be designed in a variety of ways.

To obtain pieces at the end of the processing, which pieces can be consumed as a bite-sized portion or can be further processed as, for example, cereal additive, it is advantageous to clear the mass of water before the final drying to such an extent that it can be portioned. This is particularly helpful when the mass no longer has a sufficiently firm consistency. For instance, a mash, a purée or a juice mixture can be evaporated or predried until the appearance of a firm consistency. Once the resulting concentrated mass has assumed a pasty or semisolid consistency, it can be brought into a defined shape and then, through this uniform shape, subjected more easily to uniform drying. Differing water contents in individual pieces of a production batch, as are known from the drying of individual fruits, can thus be avoided.

To further solidify the consistency of the mass, the addition of further ingredients for texturizing or for water binding is also possible. In this case, it is, for example, possible to use dried ground fruits/vegetables, flours from plant-based raw materials such as grains, legumes, oilseeds or the like. The addition of press residues from the drinks industry, fiber preparations or proteins is conceivable too for solidifying the consistency of the mass before the drying. Besides the stabilization of the mass before the drying, the addition of the stated ingredients to the mass before the drying also offers the possibility of altering the texture of the dried end products and of making the firmness, the acoustics and the bite of the dried products more attractive for the consumers. Especially when using proteins, press residues and insoluble fibers, this can be varied easily.

Besides the direct use of the dried products according to the invention as fruit and/or vegetable snacks, it is also possible to process the dried products to form further products such as cereal additive, cereal bar, additive for granola yoghurts, salad croutons, powder or granulate for producing drinks, chocolate filler, praline filling, sausage filler, baking additives, for preparing teas, as decoration for different applications, etc.

To dry the mass particularly uniformly, it may also be advantageous to produce uniform rods, sausages or other geometric shapes having a uniform and constant surface/volume ratio from the mass and to dry them up to a defined water content. After this drying step, these relatively large pieces can then be easily cut up into bite-sized portions using mechanical cutting units and, optionally, be postdried thereafter in a second drying step, if this is still necessary in order to achieve a water content of below 10% by mass.

The processing of the mass before the complete drying up to a crispy consistency has the advantage that it is possible, in comparison with the hitherto drying of entire fruits or fruit pieces, to produce dried products in defined shapes (e.g., in the shape of a heart, cube, star or animal). The shaping before the drying has the positive effect that there is no pulverulent dust which would arise in the shaping of the completely dried products.

### Shape

To achieve a desired portioning of the herein-described dried products, various approaches are possible. For example, a moist mass composed of comminuted constituents of at least one fruit variety can be filled into frames and be predried to form cuttable plates or sheets so that they can then be cut into strips, cubes or other geometries of desired size. Cuttable sheets or plates can be provided in differing layer thickness. A layer thickness can be preferably between 0.9 and 15 mm (e.g., 1 mm, 1.5 mm, 2 mm, 3 mm 4 mm, 5 mm, 6 mm, 7 mm, 8 mm, 9 mm, 10 mm, 11 mm, 12 mm, 13 mm or 14 mm). Depending on the use of the dried product, the layer thickness can be less than 3 mm (e.g., 2.5 mm, 2 mm, 1.5 mm, 1 mm, 0.5 mm or less). The layer thickness can also be above 15 mm (e.g., 16 mm, 17 mm, 18 mm, 19 mm, 20 mm, 21 mm, 22 mm, 23 mm, 24 mm, 25 mm). The portioning of the dried product according to the invention can be chosen such that it is suitable for the intended use (e.g., as snack product, cereal additive, cereal bar, additive for granola yoghurts, salad crouton, powder, granulate for producing drinks, chocolate filler, praline filling, sausage filler, or baking additive).

Alternatively, dried products to be produced can also be portioned and shaped using a dough piping bag or pastry press. In this case, a certain viscosity is required in order to keep the desired shaping stable for further processing steps. An injectable mass of sufficient viscosity can, as described herein, be ensured through use of fruit having a high content of dried substance (e.g., banana), through the pre-evaporation of water, the addition of predried fruits or the degree of comminution. Furthermore, it is also possible to use extrusion technology or pastry machines for a desired portioning. Lastly, it is also possible to use 3D printing methods in order to achieve a desired portioning and shape for the dried products according to the invention. The portioning can, again, be chosen such that the dried product according to the invention is suitable for the intended use. This can be achieved through simple portioning before the drying, for example into appropriate shapes such as hearts, stars, flowers, circles, triangles, squares or the like.

### Color

The dried products produced according to the herein-described method can be single-colored or multicolored. By combining constituents of different fruit varieties and with avoidance of color changes due to oxidation, various color combinations are possible through the fruit-endogenous colorings. These can go from a very light yellow (e.g., when using pure banana as starting material) up to very dark hues (red, green, blue). By mixing fruit varieties, it is possible to achieve further shades.

Herein-described dried products can be characterized in terms of their color by means of L*a*b* color measurement. Here, the L* value is the lightness coordinate and the values a* and b* appear as color axes. The value of the L* axis extends from 0 (black) to 100 (white). The red-green axis is represented here by the a* value. Here, negative values are the green color portion and the positive values are the red portion. The b* value by contrast characterizes the shades blue and yellow. Negative values symbolize the blue color spectrum and positive values are distinguished by the yellow portion.

### Homogeneity

A particular distinguishing feature in relation to conventional fruit snacks consisting of entire fruit pieces is the homogeneity of the color in dried products according to the invention. However, this is only the case when seed- or stone-containing fruits are not used or the seeds/stones/nutlets are removed beforehand or very finely comminuted (e.g., the stones from raspberry or nutlets of strawberries).

### Water Content and Texture

The final water content can be reduced to 2% to 10% by weight (e.g., 3%, 4%, 5%, 6%, 7%, 8% or 9%). This water content is helpful for ensuring the desired product properties, such as crispiness, but also shelf life.

Characterizing properties of dried products according to the invention can—apart from human sensory methods—be described by machine-based texture analysis. For example, the Liu method (Liu, Chenghai; Zheng, Xianzhe; Shi, John; Xue, Jun; Lan, Yubin; Jia, Shuhua (2010): Optimising micro-wave vacuum puffing for bluehoneysuckle snacks. In: Food Science and Technology 45, pages 506-511) makes it possible to test for the parameters breaking force and crispiness.

The crispiness of the dried products according to the invention is defined according to the Liu method as the number of significant fractures in a first positive bite region. In a force-time chart, crispiness can be expressed according to said method as the number of peaks which precede a maximum peak, which in turn can represent the complete fracture of a dried product at the end of a first positive bite region. The height of the individual peaks has an influence too on the sensory experience of crispiness. In the case of very low peaks, it is possible to perceive more a quiet crispy noise before the fracture of the sample; high peaks bring about a louder noise and a higher level of crispiness.

In the case of the dried products according to the invention, there was found to be a dependence of the observed crispiness on the water content before the microwave drying (puffing), the conditions during the microwave drying (puffing) (e.g., duration, pressure, temperature or microwave intensity).

A homogeneous, crispy texture can be a characteristic of the dried products according to the invention when using pure or mixed and finely comminuted purées as raw material.

### EXAMPLES

### Example 1—Sugar and Vitamin C Content of Dried Products

Dried fruit products based on press cake can generally be prepared according to the following protocol:

1. Fresh fruit that will be used as base material is cleaned and peeled.

2. The fruit goes to an extraction step as long as necessary to separate the juice and the pressed cake. The juice can be further use as desired.

3. The press cake can be processed to a snack by its own or can be further mixed with other fruits and or vegetables.
a. The other fruits and or vegetables can be fresh or already a puree.
b. If the fruits and or vegetables are fresh, they are washed and peeled when necessary.
c. The amounts of added fruits and or vegetables depend on the desired requirements of sugar, texture, nutrient content (e.g., vitamin C), and color.
d. The mixture of press cake with fruits and or vegetables are mixed until homogeneous (the time depends on the amount prepared).

4. A sample of the pressed cake or the mixture is analyzed for water content. 5. The pressed cake or mixture are placed on frames (for example, 0.5 cm, 0.30 cm or 0.25 cm height).
a. The weight of the tray, frame and Teflon sheet is previously weighed.

6. The press cake or mixture is extended evenly on the frame.

7. Predrying step: The tray is placed in a homogeneous air flow oven for as long as necessary (4-6 h in some examples) until the product reaches the required water content (40-30% in some examples). The trays are taken out of the oven manually.

8. The pre-dried pressed cake or mixture is separated from the frames and cut into the desired shapes. Knifes, scissors or cookie forms can be used but various machines can also be used for scale-up.

9. The pre-dried pieces are placed in the plate for the microwave.

10. The microwave vacuum lasts 110 seconds (or less) in some examples. Then the plate is transferred to the post drying chamber under vacuum conditions and it is maintained there for ca. 5 h in some examples. The transferring step can take place under vacuum conditions or under atmospheric conditions.

11. The samples are collected after the post drying and packed (for example in less than 10 min to avoid humidity from the air to be absorbed by the samples).

Dried products according to the invention were subjected to an analysis of the content in water-soluble saccharides. Specifically, the commercially available kit Enzytec™ from r-biopharm was used to determine the amount of sugars such as fructose, glucose and sucrose.

The enzymatic test employs β-Fructosidase (Invertase), Hexokinase (HK), Phosphoglucose Isomerase (PGI) and Glucose-6-Phosphate Dehydrogenase (G6P-DH). NADH is produced and is measured at 340 nm to determine the sugar concentration.

In addition to a determination of the sugar content, dried products according to the invention have further been analyzed for their Vitamin C content. The Vitamin C content was determined using the VitaFast™ assay from r-biopharm. The test is based on the reductive property of ascorbate using the enzyme ascorbate oxidase.

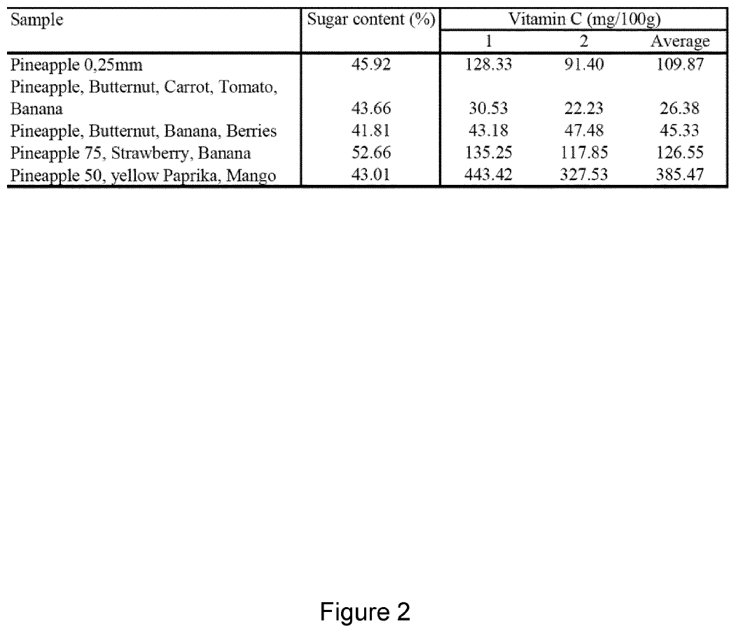

FIG. 2 shows that the sugar content in dried products based on press cake can be reduced to less than 60%, in some cases to less than 50%.

These results demonstrate that dried products based on a press cake as described herein have a strongly reduced sugar content, while the content of Vitamin C is only moderately reduced.

### Example 2—Color Measurements of Dried Products

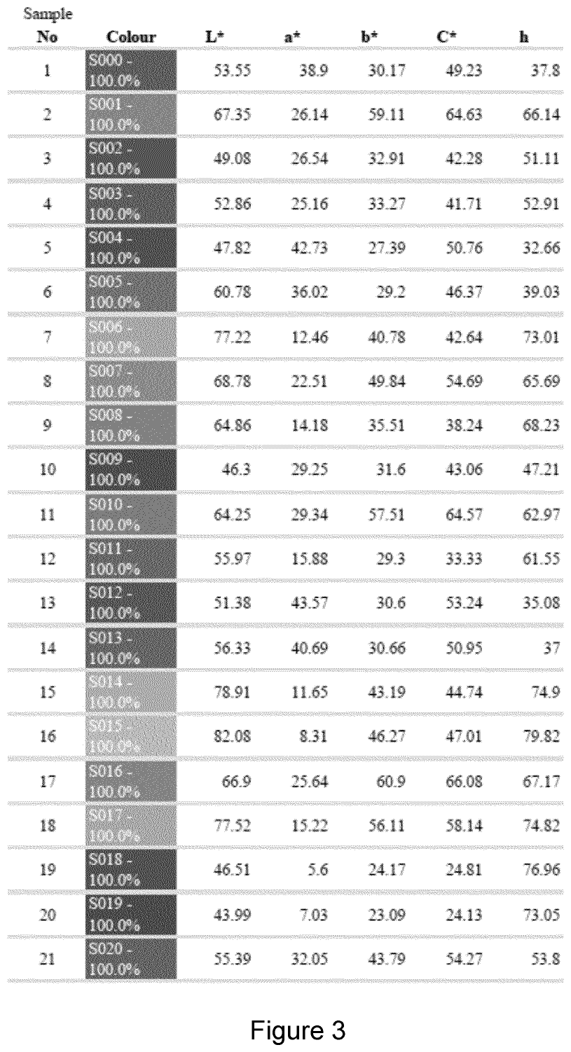

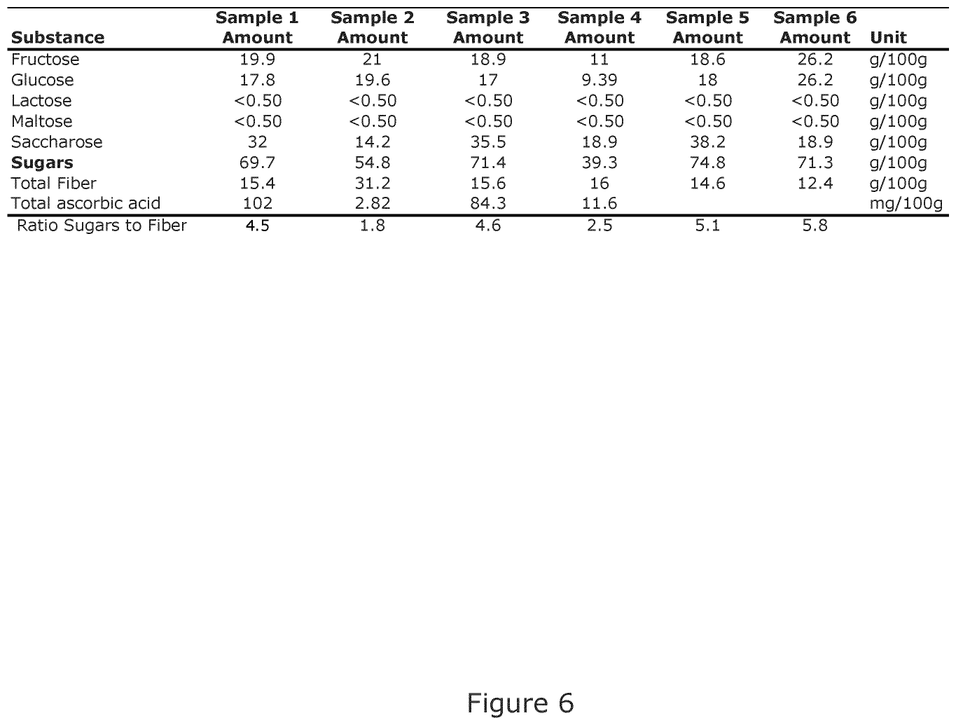

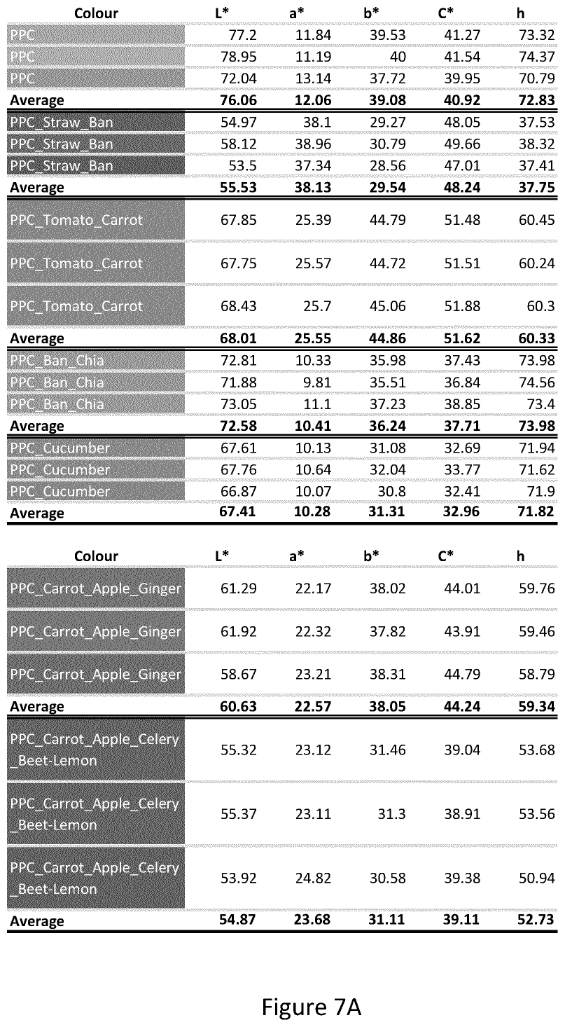

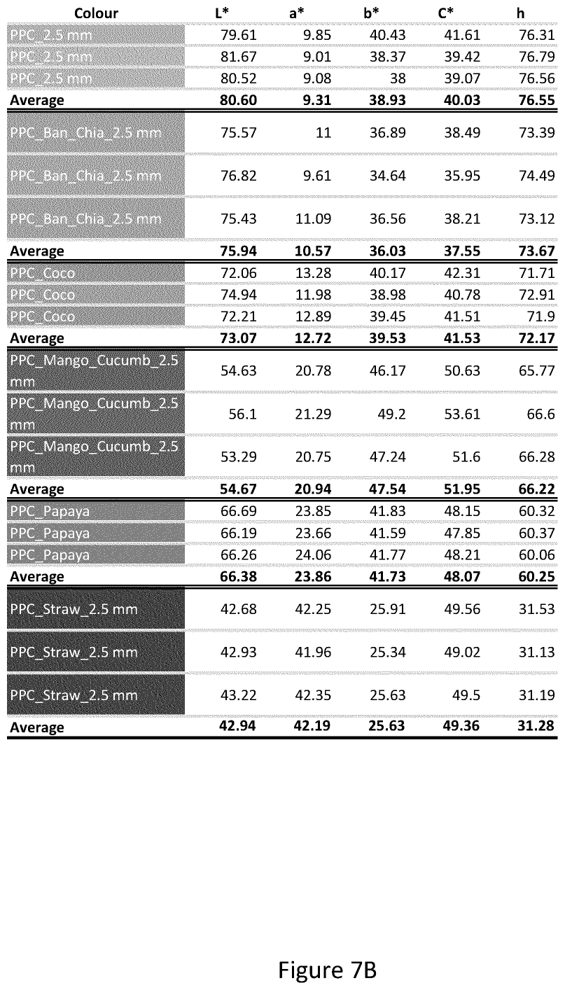

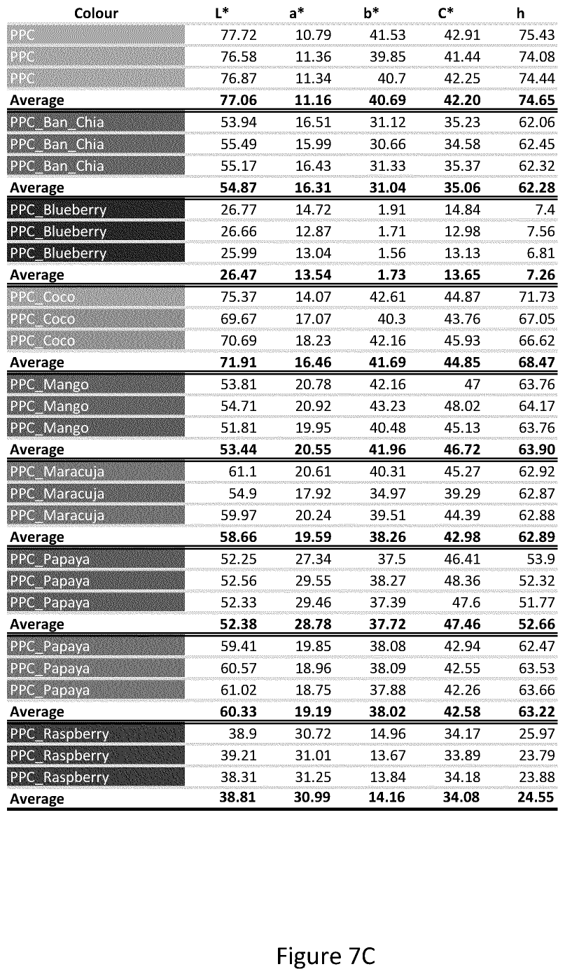

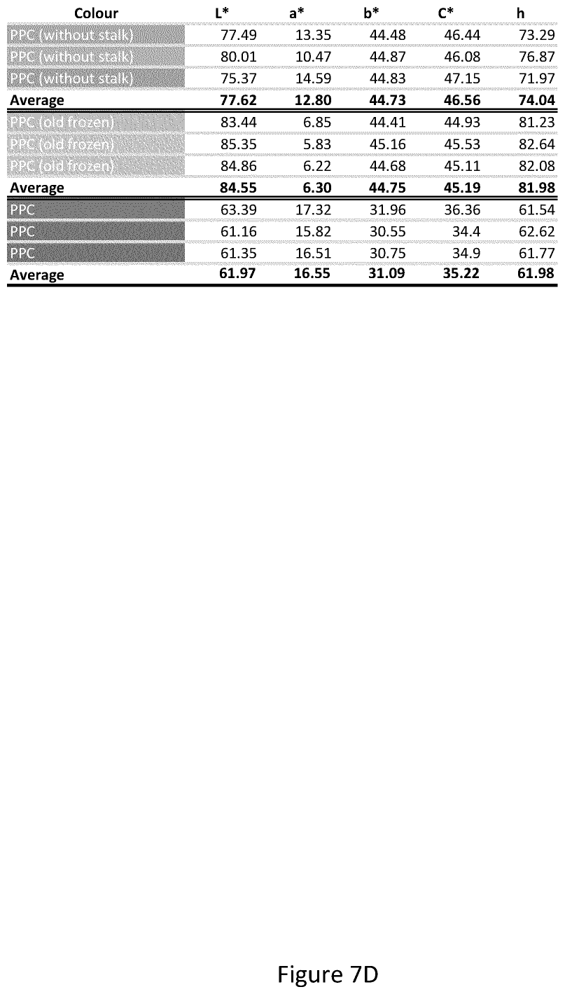

Various dried products according to the invention have been characterized in terms of their color by means of L*a*b* color measurements described above (FIG. 3). FIGS. 6A-D show color measurements of further dried products based on press cake. The color measurements of the products shown in FIGS. 6A-D can be summarized as follows:

TABLE 1
Summary of color measurements shown in FIGS. 6A-D:

| | L* | a* | b* | C* | h |
|---|---|---|---|---|---|
| highest value | 84.55 | 42.35 | 49.2 | 53.61 | 82.64 |
| lowest value | 25.99 | 5.83 | 1.56 | 12.98 | 6.81 |
| Average in total | 62.67 | 18.98 | 35.42 | 41.59 | 60.27 |

Combining constituents of different fruit varieties allows for obtaining various color combinations through the endogenous colorings of the fruit. Further, comminution and mixing of different parts of the fruit allows for the preparation of dried products having a more homogenous and more appealing appearance.

### Example 3—Nutritional Values and Sugar to Fiber Ratios of Dried Products

Dried products according to the invention advantageously reduce the ratio of a mass of water-soluble saccharides to a mass of soluble and insoluble fiber in the press cake.

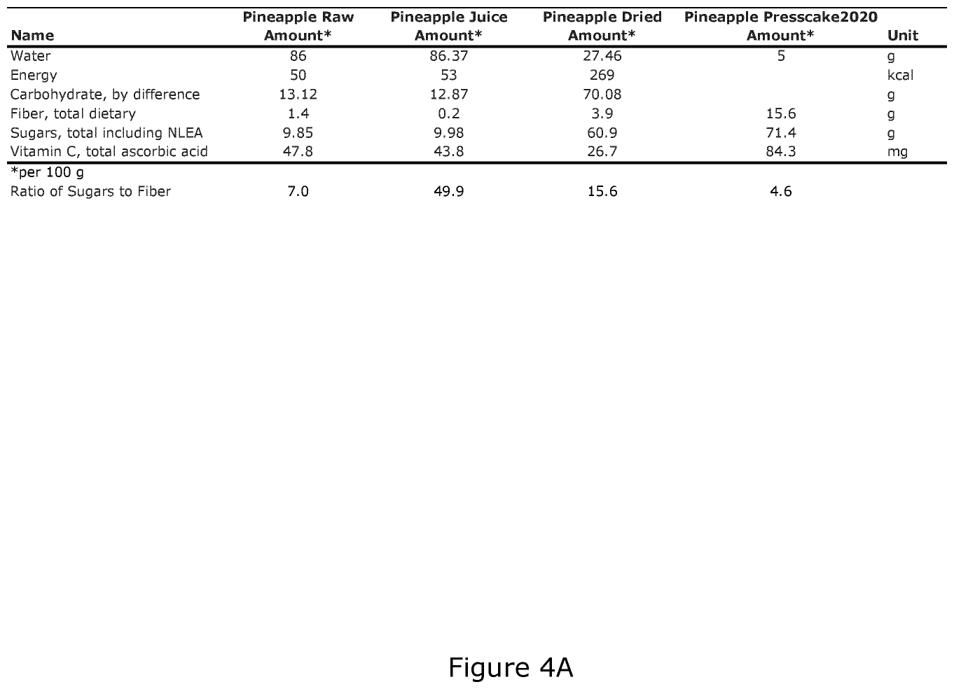

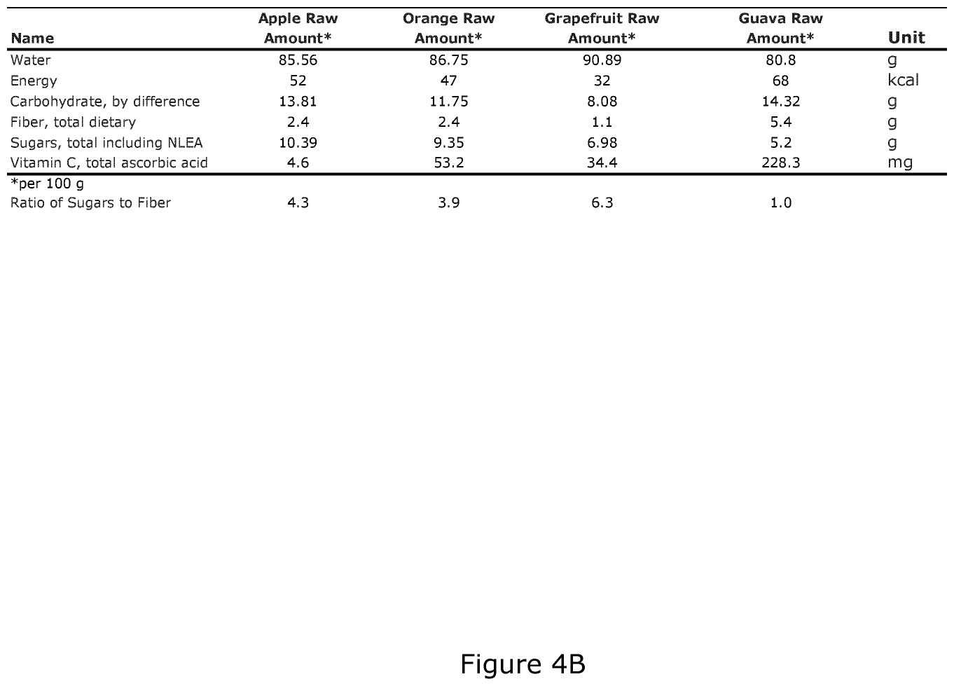

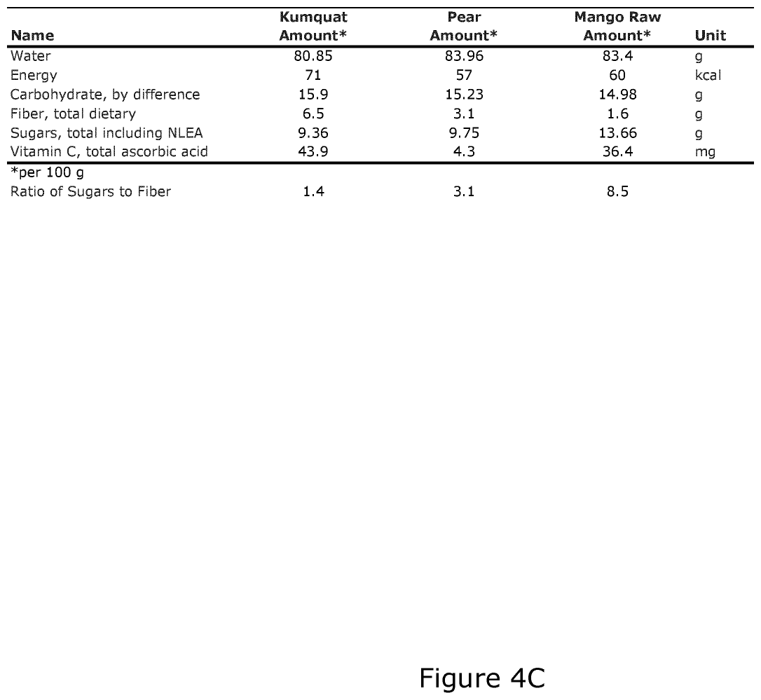

FIG. 4A illustrates this reduction based on a pineapple press cake product according to the invention in comparison to other products based on pineapple as a raw material. As shown in FIG. 4A, said ratio adopts a value of 4.6 in a dried product based on pineapple press cake. In contrast, said ration adopts a value of 7.0 in raw pineapple, 15.6 in dried pineapples, and 49.9 in pineapple juice. Accordingly, dried products based on press cake have a lower ratio of water-soluble saccharides to total dietary fiber.

FIGS. 4B-C depict the ratio of a mass of water-soluble saccharides to a mass of soluble and insoluble fiber in raw materials of further fruit varieties. The masses of water-soluble saccharides are based on a sugar spectrum HPLC detecting fructose, glucose, sucrose, lactose, and maltose (DIN 10758: 1997-05 (mod.)). The mass of water-soluble saccharides used for the calculation of the ratio corresponds to the different sugar spectra for fructose, glucose, sucrose, lactose, and maltose. The amount of ascorbic acid was determined by extracting ascorbic acid from the raw fruit materials with acetonitrile and measuring ascorbic acid via HPLC and a UV and electrochemical detection. Isoascorbic acid was added as an internal standard. The method is typically applied for determining ascorbic acid in food products. The detection limit is 10 mg/kg. The total fiber content is determined based on a standardized method (§ 64 LFGB L 00.00-18: 1997-01).

In raw apple, the ratio is 4.3. Dried products based on apple press cake allow for reducing said ratio to a range from 0.9-3.9 corresponding to 20%-90% of said ratio in raw apple. In raw orange, the ratio is 3.9. Dried products based on orange press cake allow for reducing said ratio to a range from 0.8-3.5 corresponding to 20%-90% of said ratio in raw orange. In raw grapefruit, the ratio is 6.3. Dried products based on grapefruit press cake allow for reducing said ratio to a range from 1.3-5.7 corresponding to 20%-90% of said ratio in raw grapefruit. In raw guava, the ratio is 1.7. Dried products based on guava press cake allow for reducing said ratio to a range from 0.3-1.5 corresponding to 20%-90% of said ratio in raw guava. In raw kumquat, the ratio is 1.4. Dried products based on kumquat press cake allow for reducing said ratio to a range from 0.3-1.3 corresponding to 20%-90% of said ratio in raw kumquat. In raw pear, the ratio is 3.1. Dried products based on pear press cake allow for reducing said ratio to a range from 0.6-2.8 corresponding to 20%-90% of said ratio in raw pear. In raw mango, the ratio is 8.5. Dried products based on mango press cake allow for reducing said ratio to a range from 1.7-7.7 corresponding to 20%-90% of said ratio in raw mango.

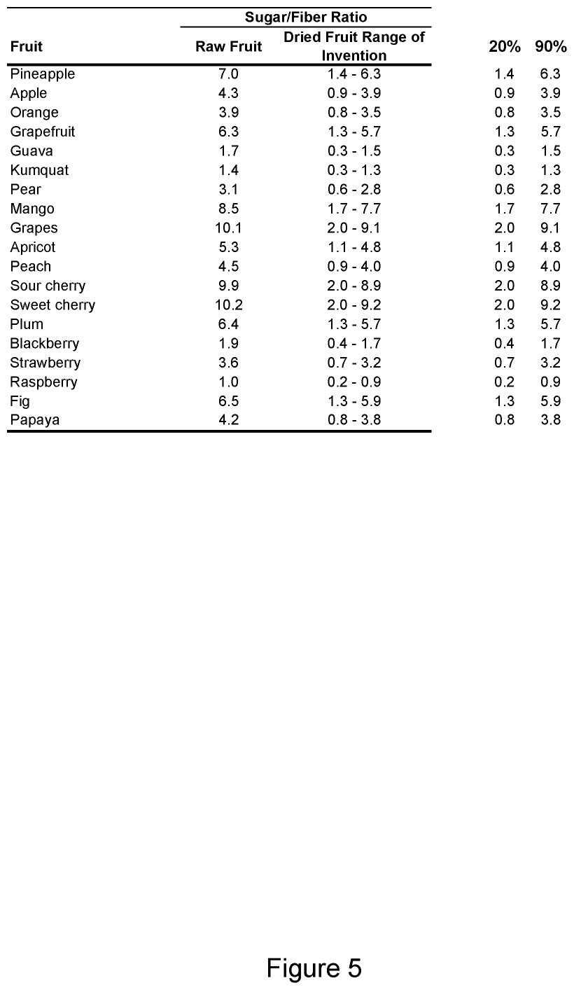

FIG. 5 summarizes the ratios calculated for raw materials of various fruit varieties and depicts the reduced ranges of the ratio achievable for dried products based on press cake in accordance with the invention. The values for the sugar and fiber contents of the depicted raw materials are publicly available at FoodData Central from the website of the U.S. Department of Agriculture (https://fdc.nal.usda.gov/, data collected on the 11 Aug. 2020) and from Belitz, H. D. and Grosch, W., and Schieberle, P.: Lehrbuch der Lebensmittelchemie. 6^{th} edition, 2008, Springer (Springer-Lehrbuch).

These examples illustrate that dried products based on press cake may advantageously reduce the ratio of a mass of water-soluble saccharides to a mass of soluble and insoluble fiber in the press cake as compared to raw materials of corresponding fruit varieties. Accordingly, dried products based on press cake may contribute to a healthy diet because of their relatively reduced content of water-soluble saccharides and relatively enriched fiber content.

### Example 4—Characterization of Dried Fruit Products

Specific dried products based on press cake according to the invention have been subjected to an in depth characterization of sugars, total dietary fiber, and vitamin C. FIG. 6 depicts the results of characterization of these products. The masses of water-soluble saccharides are based on a sugar spectrum HPLC detecting fructose, glucose, sucrose, lactose, and maltose (DIN 10758: 1997-05 (mod.)). The value for “sugars” is based on the different sugar spectra for fructose, glucose, sucrose, lactose, and maltose. Amounts below the detection limit have not been taken into account for calculating the sum for “sugars”. The amount of ascorbic acid is based on a standardized method (QMP_504_KI_52_020: 2018-02 (HPLC)). The total fiber content is also based on a standardized method (§ 64 LFGB L 00.00-18: 1997-01).

Sample 1 is a dried pineapple press cake snack based on pineapples without core. The ratio of the mass of these water-soluble saccharides to the mass of total dietary fiber in the press cake is 4.5.

Sample 2 is a dried pineapple press cake snack based on pineapple cores. The ratio of the mass of these water-soluble saccharides to the mass of total dietary fiber in the press cake is 1.8.

Sample 3 is a dried pineapple press cake snack based on complete pineapples. The ratio of the mass of these water-soluble saccharides to the mass of total dietary fiber in the press cake is 4.6.

Sample 4 is a dried pineapple press cake snack based on complete pineapples with an addition of shredded coconut. The ratio of the mass of these water-soluble saccharides to the mass of total dietary fiber in the press cake is 2.5.

Sample 5 is a dried Pineapple pressed cake snack based on complete pineapples. The ratio of the mass of these water-soluble saccharides to the mass of total dietary fiber in the press cake is 5.1.

Sample 6 is a dried pineapple press cake-banana-chia snack. The ratio of the mass of these water-soluble saccharides to the mass of total dietary fiber in the press cake is 5.8.

### Example 5—Fracture Force Measurements of Dried Fruit Products

Various dried fruit products based on press cakes have been subjected to fracture force measurements. Fracture forces were measured based on the method described in Xu and Kerr, LWT—Food Science and Technology, 48(1):96-101, September 2012 with some modification. Briefly, a Texture Analyzer XT Plus with a 50 kg load cell was used. The rig consisted of a 15 mm cylindrical base sample holder and a 6 mm ball (P/0.25S) used to penetrate the sample. The speed test was 1 mm/s with a travel distance of 3 mm. Test results were obtained at least in 8 replicate samples.

| | |
|---|---|
| | Fracture Force |
| Sample | g |

Presscake samples

| | |
|---|---|
| PPC snack | 1898.07 ± 502.88 |
| PPC snack-Raspberry | 307.51 ± 93.29 |
| PPC snack circle | 328.59 ± 104.45 |
| PPC snack circle 2 | 180.94 ± 135.18 |
| PPC snack 2 | 336.37 ± 192.27 |
| PPC-BananaChia | 392.36 ± 158.96 |
| PPC-Coconut | 472.51 ± 177.37 |

Commercial Products

| | |
|---|---|
| Pringles ™ | 101.93 ± 21.00 |
| KesselChips ™ | 461.94 ± 148.02 |
| TortillaChips ™ | 328.57 ± 160.47 |

Table 3 shows the results of fracture force measurements for dried fruit products based on press cakes:

| | |
|---|---|
| | Fracture Force |
| Sample | g |

Start Charge: PPC Snack

| | |
|---|---|
| PPC Snack2 | 1319.06 |
| PPC Snack3 | 1380.67 |
| PPC Snack4 | 2051.40 |
| PPC Snack5 | 1749.97 |
| PPC Snack6 | 1757.51 |
| PPC Snack7 | 2939.32 |
| PPC Snack8 | 2205.01 |
| PPC Snack9 | 1294.81 |
| PPC Snack10 | 2457.59 |
| PPC Snack11 | 1825.39 |
| Average | 1898.07 |
| S.D. | 502.88 |
| C.V. | 26.49 |

Start Charge: PPC Snack- Raspberry

| | |
|---|---|
| PPC Snack- Raspberry1 | 265.92 |
| PPC Snack- Raspberry2 | 263.37 |
| PPC Snack- Raspberry3 | 234.60 |
| PPC Snack- Raspberry4 | 476.85 |
| PPC Snack- Raspberry5 | 347.14 |
| PPC Snack- Raspberry6 | 313.26 |
| PPC Snack- Raspberry7 | 228.91 |
| PPC Snack- Raspberry8 | 304.44 |
| PPC Snack- Raspberry9 | 242.49 |
| PPC Snack- Raspberry10 | 208.03 |
| PPC Snack- Raspberry11 | 497.62 |
| Average | 307.51 |
| S.D. | 93.29 |
| C.V. | 30.34 |

Start Charge: PPC snack circle

| | |
|---|---|
| PPC snack circle3 | 428.59 |
| PPC snack circle4 | 373.48 |
| PPC snack circle5 | 331.71 |
| PPC snack circle6 | 244.11 |
| PPC snack circle7 | 227.52 |
| PPC snack circle8 | 554.36 |
| PPC snack circle9 | 315.58 |
| PPC snack circle10 | 275.09 |
| PPC snack circle11 | 206.87 |
| Average | 328.59 |
| S.D. | 104.45 |
| C.V. | 31.79 |

Start Charge: PPC snack circle

| | |
|---|---|
| PPC snack circle12 | 292.53 |
| PPC snack circle13 | 281.92 |
| PPC snack circle14 | 362.17 |
| PPC snack circle15 | 84.67 |
| PPC snack circle16 | 35.78 |
| PPC snack circle17 | 104.35 |
| PPC snack circle19 | 70.84 |
| PPC snack circle20 | 67.02 |
| PPC snack circle21 | 433.25 |
| PPC snack circle22 | 493.23 |
| PPC snack circle23 | 136.55 |
| PPC snack circle24 | 213.23 |
| PPC snack circle25 | 108.76 |
| PPC snack circle26 | 89.44 |
| PPC snack circle27 | 156.82 |
| PPC snack circle28 | 129.39 |
| PPC snack circle29 | 351.20 |
| PPC snack circle30 | 61.89 |
| PPC snack circle31 | 48.77 |
| PPC snack circle32 | 97.07 |
| Average | 180.94 |
| S.D. | 135.18 |
| C.V. | 74.71 |

Start Charge: PPC snack_09072020

| | |
|---|---|
| PPC snack_090720201 | 751.18 |
| PPC snack_090720202 | 136.19 |
| PPC snack_090720203 | 126.29 |
| PPC snack_090720204 | 475.46 |
| PPC snack_090720205 | 226.46 |
| PPC snack_090720206 | 230.28 |
| PPC snack_090720207 | 425.38 |
| PPC snack_090720208 | 416.31 |
| PPC snack_090720209 | 429.67 |
| PPC snack_0907202010 | 124.38 |
| PPC snack_0907202011 | 151.93 |
| PPC snack_0907202012 | 542.96 |

Ende Charge: PPC snack_09072020

| | |
|---|---|
| Average | 336.37 |
| S.D. | 192.27 |
| C.V. | 57.16 |

Start Charge: PPC-BananaChia-M

| | |
|---|---|
| PPC-BananaChia-M1 | 354.90 |
| PPC-BananaChia-M2 | 222.05 |
| PPC-BananaChia-M3 | 62.49 |
| PPC-BananaChia-M4 | 410.11 |
| PPC-BananaChia-M5 | 628.47 |
| PPC-BananaChia-M6 | 391.15 |
| PPC-BananaChia-M7 | 243.28 |
| PPC-BananaChia-M8 | 337.73 |
| PPC-BananaChia-M9 | 546.18 |
| PPC-BananaChia-M10 | 463.66 |
| PPC-BananaChia-M11 | 622.26 |
| PPC-BananaChia-M12 | 426.09 |

Ende Charge: PPC-BananaChia-M

| | |
|---|---|
| Average | 392.36 |
| S.D. | 158.96 |
| C.V. | 40.51 |

Start Charge: PPC-Coconut-M

| | |
|---|---|
| PPC-Coconut-M13 | 236.12 |
| PPC-Coconut-M14 | 748.20 |
| PPC-Coconut-M15 | 663.05 |
| PPC-Coconut-M16 | 464.49 |
| PPC-Coconut-M17 | 459.72 |
| PPC-Coconut-M18 | 752.97 |
| PPC-Coconut-M19 | 458.89 |
| PPC-Coconut-M20 | 225.15 |
| PPC-Coconut-M21 | 600.32 |
| PPC-Coconut-M22 | 434.80 |
| PPC-Coconut-M23 | 296.46 |
| PPC-Coconut-M24 | 329.97 |

Ende Charge: PPC-Coconut-M

| | |
|---|---|
| Average | 472.51 |
| S.D. | 177.37 |
| C.V. | 37.54 |

Table 4 shows the results of fracture force measurements for commercially available, maize- or potato-based snack products for comparison:

| | |
|---|---|
| | Fracture Force |
| Commercial Products | g |

Start Charge: Pringles ™

| | |
|---|---|
| Pringles1 | 105.37 |
| Pringles2 | 90.26 |
| Pringles3 | 117.44 |
| Pringles5 | 107.36 |
| Pringles6 | 133.47 |
| Pringles7 | 140.5 |
| Pringles8 | 100.6 |
| Pringles9 | 88.41 |
| Pringles10 | 126.85 |
| Pringles11 | 98.35 |
| Pringles12 | 57.13 |
| Pringles13 | 98.22 |
| Pringles14 | 89.07 |
| Pringles16 | 75.29 |
| Pringles17 | 100.6 |

Ende Charge: Pringles ™

| | |
|---|---|
| Average | 101.93 |
| S.D. | 21.00 |
| C.V. | 20.61 |

Start Charge: KesselChips ™

| | |
|---|---|
| KesselChips1 | 671.08 |
| KesselChips2 | 605.61 |
| KesselChips4 | 398.44 |
| KesselChips5 | 248.39 |
| KesselChips6 | 405.99 |
| KesselChips7 | 708.99 |
| KesselChips8 | 389.16 |
| KesselChips11 | 363.18 |
| KesselChips12 | 246.8 |
| KesselChips13 | 553.12 |
| KesselChips14 | 390.62 |
| KesselChips15 | 561.87 |

Ende Charge: KesselChips ™

| | |
|---|---|
| Average | 461.94 |
| S.D. | 148.02 |
| C.V. | 32.04 |

Start Charge: TortillaChips ™

| | |
|---|---|
| TortillaChips16 | 239.38 |
| TortillaChips17 | 368.88 |
| TortillaChips18 | 222.28 |
| TortillaChips19 | 306.98 |
| TortillaChips20 | 204.78 |
| TortillaChips21 | 237.39 |
| TortillaChips22 | 422.96 |
| TortillaChips23 | 264.43 |
| TortillaChips24 | 891.91 |
| TortillaChips25 | 214.33 |
| TortillaChips26 | 295.31 |
| TortillaChips27 | 475.84 |
| TortillaChips28 | 315.73 |
| TortillaChips29 | 222.02 |
| TortillaChips30 | 389.69 |
| TortillaChips31 | 234.08 |
| TortillaChips32 | 279.67 |

Ende Charge: TortillaChips ™

| | |
|---|---|
| Average | 328.57 |
| S.D. | 160.47 |
| C.V. | 48.84 |

Table 5 summarizes the results of the fracture force measurements:

| | |
|---|---|
| | Fracture Force |
| Press cake samples | g |

| | |
|---|---|
| highest value | 2939 |
| lowest value | 48.77 |
| Average in total | 504.12 |

Commercial Products

| | | |
|---|---|---|
| highest value | 708.99 | Kessel Chips ™ |
| lowest value | 57.13 | Pringles ™ |

### Example 6—Thickness and Crispiness of Dried Fruit Products

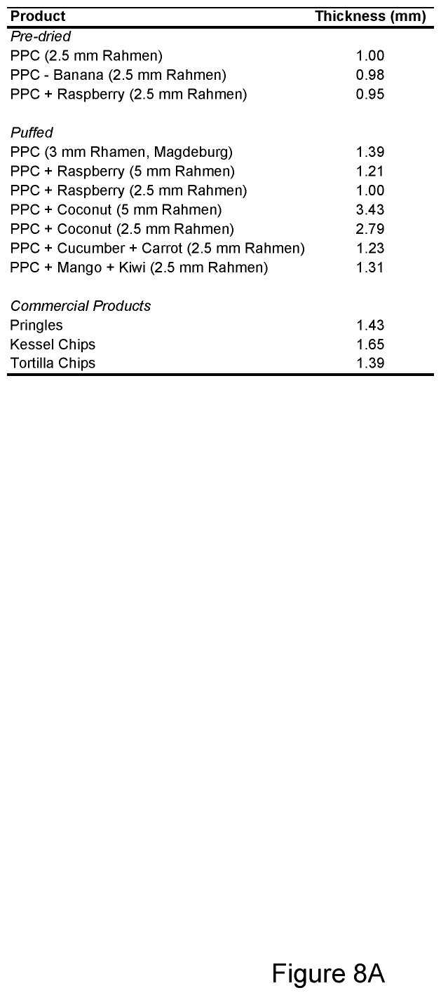

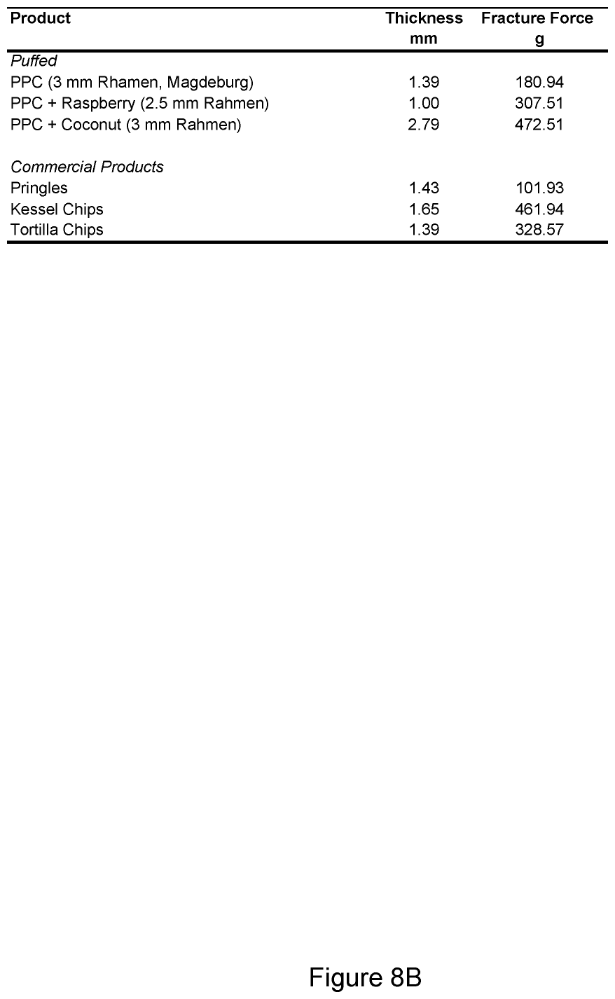

The press cakes obtained by de-juicing raw materials of food varieties as described herein can be processed using the methods of the invention to have the pleasant size and thickness of a snack product. FIG. 8 shows the thickness of various dried products after pressing in a pre-dried state before puffing and after a puffing step. The pre-dried press cakes can be formed to a thickness between 0.9 mm and 1 mm. The puffing step leads to a volume expansion, the degree of which depends on the fruit varieties whose raw materials were used to obtain the press cake. As can be seen from FIG. 8A, dried products according to the invention after a puffing step can have the thicknesses between 1 mm and 3.5 mm. This thickness is in a range comparable to popular potato-based snack products as shown in FIG. 8A. FIG. 8B provides a comparison of fracture force measurements for dried fruit products based on press cake and potato-based snack products. As FIG. 8B shows, dried products according to the invention can be flexibly prepared and processed to require fracture forces in the range of 180 g and 470 g. Consumers are familiar with this range from more or less crispy potato chips.

Accordingly, the dried fruit products based on press cake are not only favorable from a nutritional perspective because of their relatively low sugar content and their relatively enriched fiber content, they also have the pleasant crispy texture of popular snack products.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A dried product made from fruit, the dried product comprising:
a press cake of constituents of at least one fruit variety,
wherein a ratio of a mass of water-soluble saccharides to a mass of soluble and insoluble fiber in the press cake is less than 90% of said ratio in a raw material of the at least one fruit variety, and
wherein the water content of the dried product is less than 10% by mass.

2. The dried product of claim 1, wherein the ratio of a mass of water-soluble saccharides to a mass of soluble and insoluble fiber in the press cake is less than 80% of said ratio in a raw material of the at least one fruit variety.

3. The dried product of claim 1, wherein the ratio of a mass of water-soluble saccharides to a mass of soluble and insoluble fiber in the press cake is less than 70% of said ratio in a raw material of the at least one fruit variety.

4.-56. (canceled)

57. A method for producing a dried product made from fruit, the method comprising the following steps:
providing constituents of at least one fruit variety;
pressing the constituents of the at least one fruit variety to obtain a press cake, wherein pressing reduces a ratio of a mass of water-soluble saccharides to a mass of soluble and insoluble fiber in the press cake to less than 90% of said ratio in the provided constituents of the at least one fruit variety;
predrying the press cake to obtain a predried mass, wherein the water content is reduced to a proportion by mass of from 60% to 35%; and
microwave drying the predried mass under reduced pressure conditions, wherein the water content of the resulting dried product is less than 16% of the mass of the dried product.

58.-63. (canceled)

64. The method of claim 57, wherein pressing reduces a ratio of a mass of water-soluble saccharides to a mass of soluble and insoluble fiber in the press cake to less than 20% of said ratio in the provided constituents of the at least one fruit variety.

65.-68. (canceled)

69. The method of claim 57, further comprising comminuting the press cake.

70. The method of claim 57, wherein the predrying is carried out at a temperature of less than 80° C. and more than 40° C.

71. The method of claim 70, wherein the predrying is carried out at a temperature of less than 60° C. and more than 40° C.

72. The method of claim 57, wherein the predrying is carried out under reduced partial pressure of oxygen.

73. The method of claim 72, wherein the predrying is carried out at a partial pressure of oxygen of less than 100 mbar and more than 10 mbar.

74.-75. (canceled)

76. The method of claim 57, wherein the microwave drying is carried out under reduced pressure conditions of less than 100 mbar and more than 10 mbar.

77.-78. (canceled)

79. The method of claim 57, wherein the microwave drying is carried out at a temperature of less than 80° C. and more than 40° C.

80.-81. (canceled)

82. The method of claim 57, further comprising foaming up the predried press cake using an inert gas after the predrying.

83. The method of claim 82, wherein the inert gas used for the foam-up is N₂.

84. The method of claim 82, wherein the proportion of inert gas after the foam-up is 10 to 30% by volume of the press cake.

85.-86. (canceled)

87. The method of claim 57, further comprising the press cake, wherein the comminuting comprises puréeing the constituents of the at least one fruit variety to form an injectable mass.

88. The method of claim 57, further comprising the press cake, wherein the comminuting comprises an extensive breakup of cellular structures.

89. The method of claim 57, wherein the microwave drying comprises an expansion of a volume to 110% to 150% of a volume of the predried mass.

90. The method of claim 57, further comprising postdrying the microwave-dried mass.

91. The method of claim 57, wherein the postdrying of the microwave-dried mass is carried out up to a water content of less than 10% by mass of the dried product, preferably less than 7%.

92. (canceled)
